(19) United States
(12) Patent Application Publication
(10) Pub. No.: US 2012/0322401 A1
(43) Pub. Date: Dec. 20, 2012

(54) METHOD AND APPLICATION FOR EMERGENCY INCIDENT REPORTING AND COMMUNICATION

(76) Inventor: Lee Collins, Reidsville, GA (US)

(21) Appl. No.: 13/164,006

(22) Filed: Jun. 20, 2011

(51) Int. Cl. H04M 11/04; G06F 17/30

(52) U.S. Cl. 455/404.1; 707/803; 707/E17.101; 707/E17.028; 707/E17.058

(57) ABSTRACT

A wireless, mobile device application for a first-responder to create incident reports for events such as an automobile accident or natural disaster, including digital photographs, audio recordings, notes, ordinance numbers, number of individuals affected, type of incident, real time global positioning satellite coordinates (GPS), and any other relevant information that a first-responder deems necessary. Such a report may then be transmitted to a server for access by emergency personnel, E-911 dispatchers, or any others with access to a secure server hosted on the World Wide Web.

### BACKGROUND OF THE INVENTION

1. Field of the Invention

This invention relates to the field of mobile device applications. More specifically, this invention relates to an application that may be downloaded onto a mobile device, which allows a user to create an incident record containing video, audio, a geographic location, notes, and other relevant information using various functions of the mobile device and then transmit the record to necessary systems and individuals.

2. Background

In many cases, there is a delay before a first responder or emergency personnel can arrive on the scene of an accident or incident f, Information provided by an individual arriving at an accident may be crucial in directing which emergency services are needed and the subsequent response. For instance, a state trooper or law enforcement officer may be summoned to a disturbance at a home and find that there are injured individuals and a fire. Such a first responding law enforcement officer will need to summon emergency medical technicians (EMTs) and fire fighting personnel and provide as much real-time information as possible. The responder also needs to document the incident and begin taking information that will be helpful to the subsequent responders. A law enforcement responder may also need to begin documenting the scene for investigative purposes.

There is no current system in which an individual can provide the real-time global positioning satellite (GPS) fixed location of the incident; photographs or videos of the incident; audio or voice recordings; initial officer notes of the incident; and/or other relevant information that a mobile device is capable of recording and saving, all of which may all be combined in one record and sent real-time to dispatchers, such that subsequent responders may have as much information as necessary to send the correct response personnel and so the subsequent responders will be more prepared regarding what to expect when arriving at the scene.

### SUMMARY OF THE INVENTION

An embodiment of the present invention provides an application for a wireless device. An embodiment may be a mobile device application that allows a mobile device user to establish a precise GPS fix for an incident location; take photographs or video; record audio; make notes regarding the incident; and/or alert other responders of potential problems or other relevant circumstances existing at the location. Such an embodiment of an application of the invention may combine all of the multi-media information created by the user into a single incident record, which may be sent to E-911 personnel or other interested recipients for review and assisting in dispatch or other action. An embodiment of the invention may also save such an incident record to a secured World Wide Web (Web) storage server or other electronic data storage, which may be accessible by other investigative authorities at a later date.

An embodiment of the invention includes a method for creating an incident report with a wireless mobile device, comprising obtaining a GPS location fix and associating said GPS fix with an incident identifier for an incident.

A further embodiment of the invention includes a method of creating an incident report, wherein said incident identifier is generated from a list of potential incident identifiers stored on electronic storage means in communication with said wireless mobile device.

A further embodiment of the invention includes a method of creating an incident report, further comprising creating an audio file and associating said audio file with said incident identifier.

A further embodiment of the invention includes a method of creating an incident report, further comprising taking a digital photograph and associating said digital photograph with said incident identifier.

A further embodiment of the invention includes a method of creating an incident report, further comprising recording a digital video and associating said digital video with said incident identifier.

A further embodiment of the invention includes a method of creating an incident report, further comprising creating a digital text file and associating said digital text file with said incident.

A further embodiment of the invention includes a method of creating an incident report, wherein said digital text file is created via voice-recognition application whereby said voice-recognition application translates a voice recording to said text file.

A further embodiment of the invention includes a method of creating an incident report, further comprising said wireless mobile device transmitting said incident report to an Emergency 911 operator.

A further embodiment of the invention includes a method of creating an incident report, further comprising said wireless mobile device transmitting said incident report to an electronic storage device.

A further embodiment of the invention includes a method of creating an incident report, wherein said electronic storage device comprises a secured server.

A further embodiment of the invention includes a method of creating an incident report, wherein said secured server may be accessible via the World Wide Web.

A further embodiment of the invention includes a system for creating an incident report, comprising: a wireless communications device with an application saved thereon capable of: fixing a GPS location; associating said GPS location with an incident identifier; recording a digital audio file and associating said audio file with said incident identifier; capturing a digital image and associating said digital image with said incident identifier; recording a digital video and associating said digital video with said incident identifier; and saving notes and associating said digital video with said incident identifier; a wireless communications network; a computer network capable of communication with said wireless communications network; and a server capable of communicating with said computer network.

A further embodiment of the invention includes a system for creating an incident report, wherein said wireless communications network is a cellular communications network.

A further embodiment of the invention includes a system for creating an incident report, wherein said computer network is the Internet

A further embodiment of the invention includes a system for creating an incident report, wherein said computer network is capable of transmitting data associated with the World Wide Web.

A further embodiment of the invention includes a system for creating an incident report, wherein said server is capable of hosting applications for the World Wide Web.

A further embodiment of the invention includes a system for creating an incident report, wherein said server is accessible only by authorized users.

A further embodiment of the invention includes a computer readable medium with instructions thereon for: generating an incident report; fixing a GPS location; capturing a digital audio recording; capturing a digital photograph; capturing a digital video; compiling said incident report, said GPS location, said digital audio recording, said digital photograph, and said digital video into a single electronic file; and transmitting said electronic file by a wireless network.

### BRIEF DESCRIPTION OF THE DRAWINGS

FIG. 1 is a logical diagram of the system of an embodiment of the invention.

FIG. 2 is a screen shot of a menu screen of an embodiment of the present invention.

FIG. 3 is a screen shot of a menu screen of an embodiment of the present invention through which a user may record audio notes in accordance with an embodiment of the invention.

FIG. 4 is a screen shot of an incident report in accordance with an embodiment of the invention.

FIG. 5 is a screen shot showing a listing of State Law and Local Ordinances for the State of Georgia in accordance with an embodiment of the invention.

FIG. 6 is a screen shot showing a menu option for code selection by the user for the category of State Law or Local Ordinance in accordance with an embodiment of the invention.

FIG. 7 is a screen shot showing an “SOS Alert” feature in accordance with an embodiment of the invention.

FIGS. 8A-8I are screen shots of browser windows showing information accessible via a secure server in accordance with an embodiment of the invention.

FIG. 9 is a screen shot of a home screen for a natural disaster or emergency disaster incident report in accordance with an embodiment of the invention.

FIG. 10 shows an example of an initial incident report for a natural disaster in accordance with an embodiment of the invention.

FIG. 11 shows an initial event window that includes types of incidents that a first-responder may select to associate with the natural disaster incident report in accordance with an embodiment of the invention.

### DETAILED DESCRIPTION OF EXAMPLE EMBODIMENTS

The present invention may be understood more readily by reference to the following detailed description of certain embodiments of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. All patents and other publications identified in this specification are incorporated by reference as thought fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

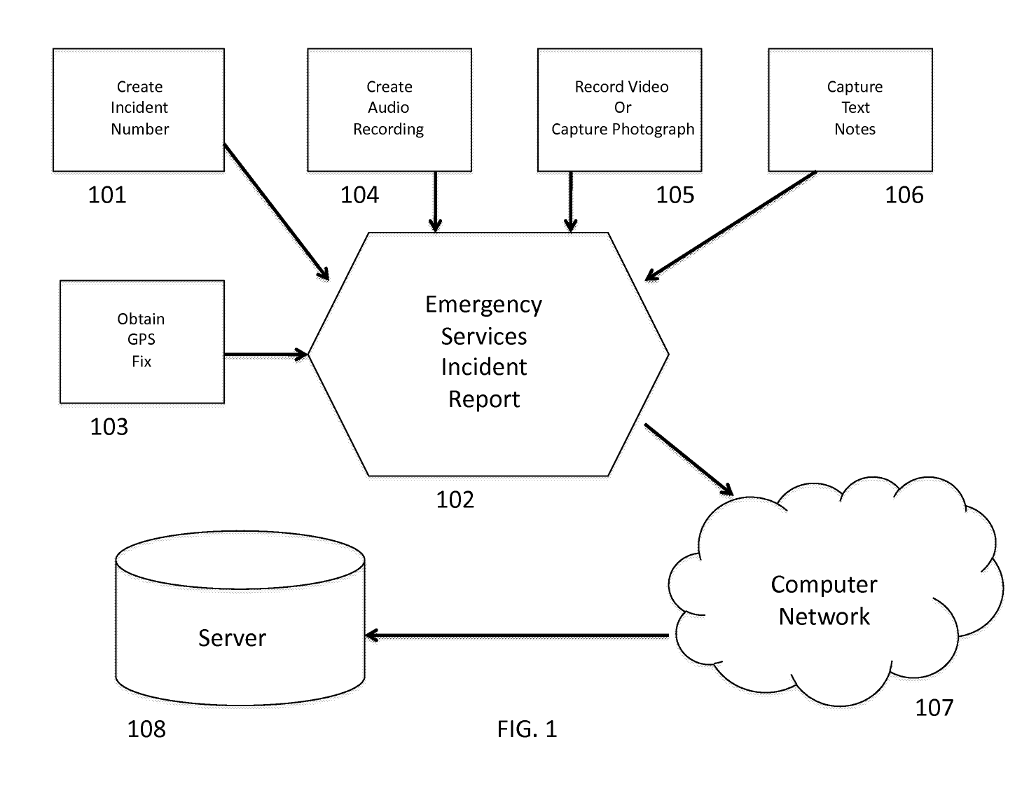

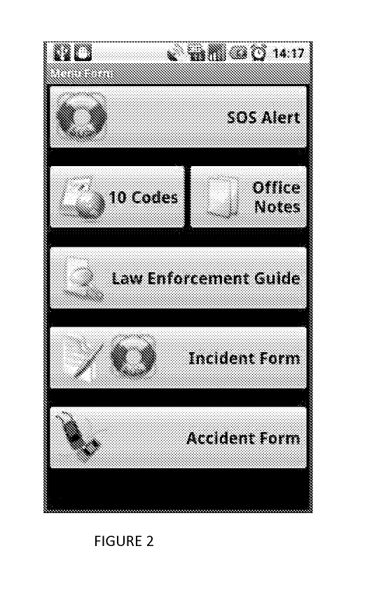

Referring now to the drawings, in which like numerals illustrate like elements throughout the several views, FIG. 1 is a logical flow chart of the method and system of the invention. At 101, an interested user, such as an emergency first responder, opens the application on his or her mobile device and initiates an incident report 102 by generating an incident number. One of ordinary skill in the art will understand that although an emergency first responder is cited herein as an exemplary user, that any interested user who may provide incident information may download and use the application. The screen shot in FIG. 2 shows a menu screen for an embodiment of the application of the invention. At 103, and substantially contemporaneously with creating the incident number 101, the application gets a fix on its location from the Global Positioning Satellite (GPS) system. The wireless device uses existing methods to determine a GPS fix. A wireless device may obtain a direct GPS fix or determine its location by triangulating its position with cellular towers. The application will determine a GPS fix or, if too much time has passed since its last GPS fix and none is available, it will triangulate the position using cellular towers. One of ordinary skill in the art will understand that the wireless device will track its GPS location as other wireless devices track their locations for the purposes of Emergency 911 calls. More specifically, the mobile device remembers its last good GPS fix. If it recognizes that the last good fix does not match with its current location and it cannot achieve a fix, it will triangulate its location with the cellular towers in range. It will be further understood that outputs of existing mapping and other applications that use GPS fixes and coordinates, such as Google Earth, Google Maps, and others may be linked to and outputs associated with the incident report 102 and the outputs used as the GPS fix 103. Such a fix or location will be associated with the incident report.

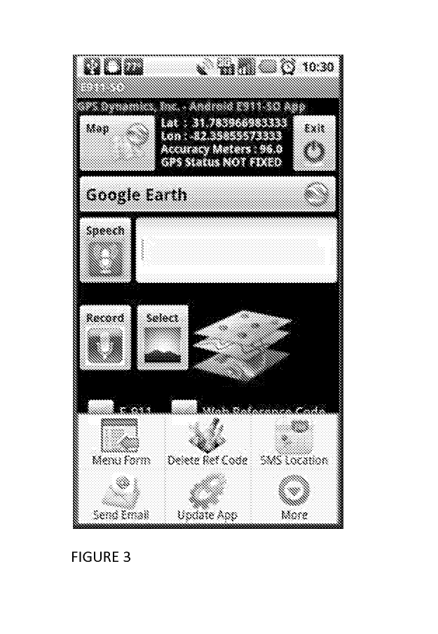

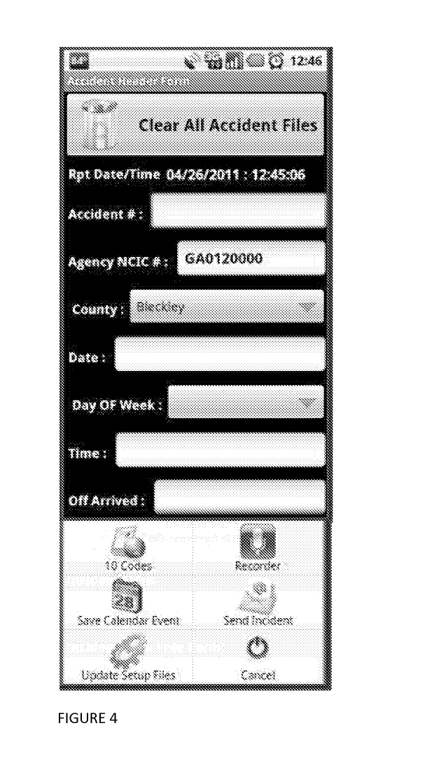

At step 104, the first responder can create an audio recording regarding the incident, including any relevant details the responder desires to send. FIG. 3 shows a screen shot of an embodiment of the application of the invention to allow the responder to record audio notes 104 to append to the incident report 102. Such details may include the number of individuals involved, the type of incident, the number of individuals injured, whether there is a fire, flooding, or the immediate effects of a natural disaster, and any other relevant details the responder wishes to include. FIG. 3 also shows a menu of options from which a first responder may select, such as sending the incident report 102 via electronic mail to a specific recipient. FIG. 4 shows a screen of an incident report in accordance with an embodiment of the invention with the various information fields that may be associated with or included in the incident report 102. FIG. 4 additionally shows options of E-mailing the incident report 102 to a recipient or saving it as a calendar event.

The first responder may also take digital photographs or video 105 of the incident scene. The photographs or video 105 may then be associated with an incident report 102. At step 106, the first responder may create text notes using a text editor available on the wireless device and associates the text notes 106 with the incident report 102. The screen shot of FIG. 3 also shows the option to take a digital photograph 105.

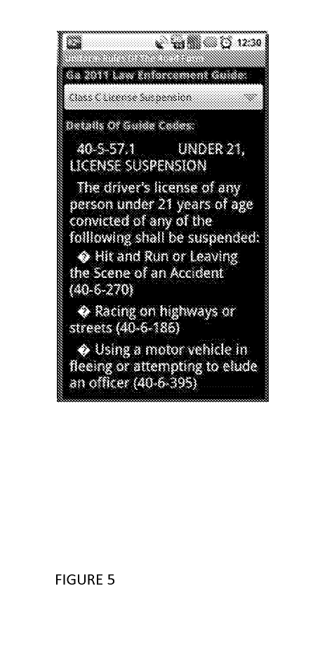

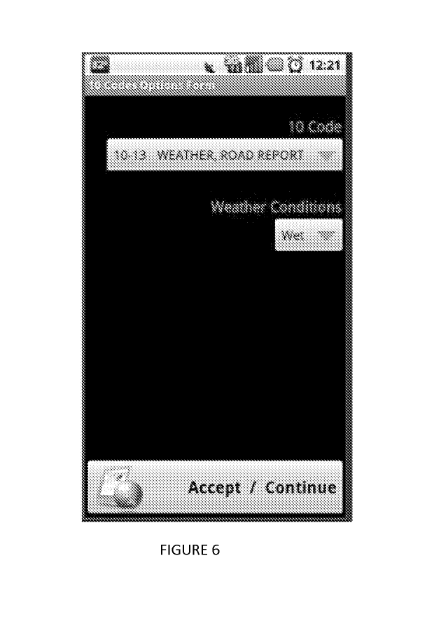

In addition to using the text editor capabilities of the wireless communication device to create and store text notes 106 in the incident report 102, the first responder may also create text notes 106 using voice-recognition software, whereby the first responder can speak the desired notes, and the software will then translate them into a text file 106 to be associated with the incident report 102. The application of an embodiment of the invention may associate the audio recording 104 with the incident report 102. Such an application may also have incorporated State Laws and Local Ordinances and the user abbreviated code therefore from which the first responder may select the relevant State Law or Local Ordinance and the identifying code. FIGS. 5 and 6 show a menu option and listing option, respectively, of the State Laws and Ordinances, and the identifying codes, which are may be searched and entered with reference to the incident report 102.

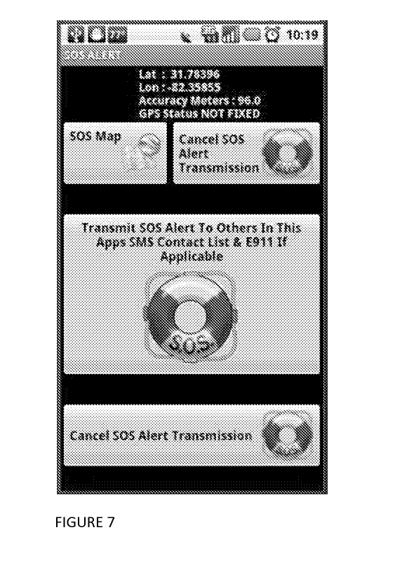

An additional feature of an application of the embodiment of the invention may also include an “SOS Alert” feature, as shown in the screen shot of FIG. 7. Specifically, a responder in distress may use the “SOS Alert” feature to transmit his or her location via text message to all other system users. The mobile device attempts to send the alert location using the last GPS fix. As when the mobile device attempts to determine its position 103 to associate with the incident report 102, the mobile device attempts to locate its position 103 for the SOS Alert. The device will attempt to secure a GPS fix, first. Failing to do so, it will triangulate its position and send the position as a text message to the other system users. The device will continue to send text messages with the triangulated coordinates until it obtains a GPS fix, which it also sends via text.

Once all desired data and entries are associated with the incident report 102, the first responder may transmit the report 102 wirelessly via a data communications network 107. One of ordinary skill in the art will understand that the computer communications network 107 may include a wireless network in communication with a wireless device, a public computer communications network in communication with a wireless network, a private computer communications network in communication with a wireless network, and any possible or necessary combination thereof. One of skill in the art will appreciate that the network and communications configuration(s) necessary will change based on desired configuration for the most efficient communication and such that is necessary to transmit the desired information to the desired recipients.

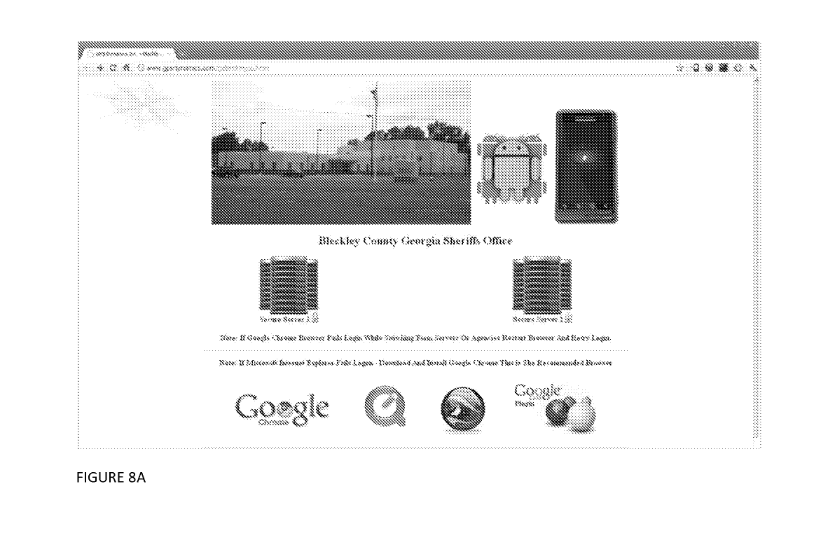

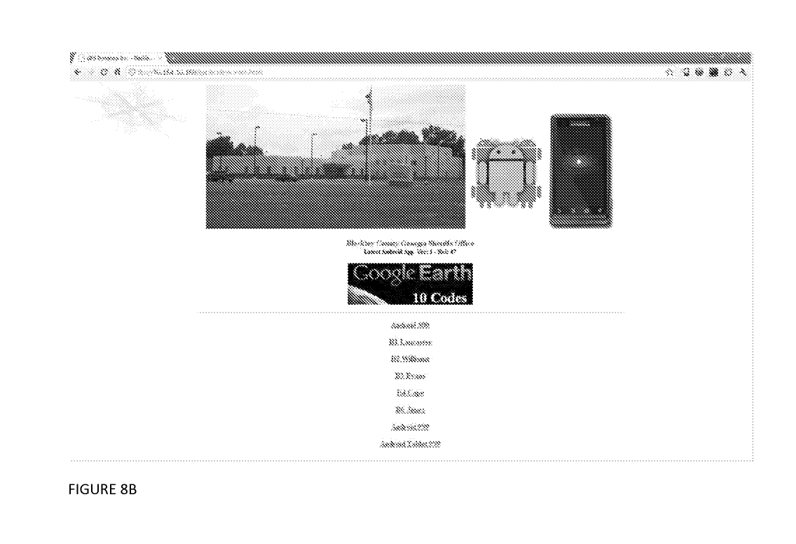

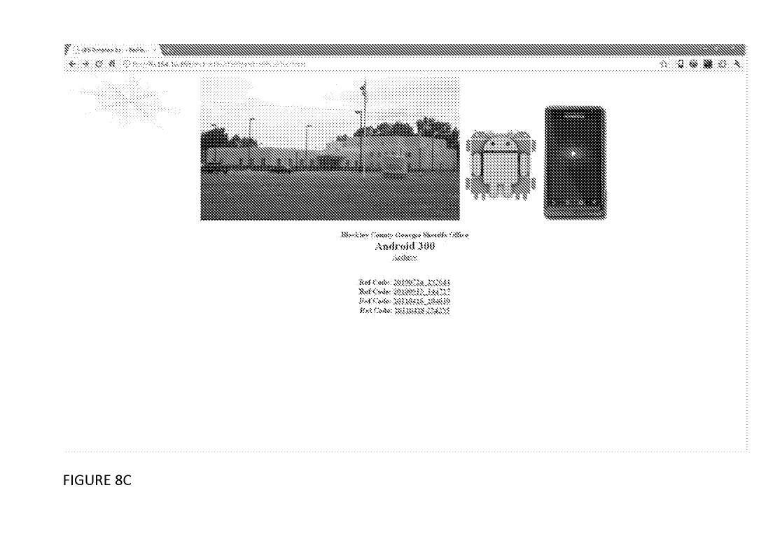

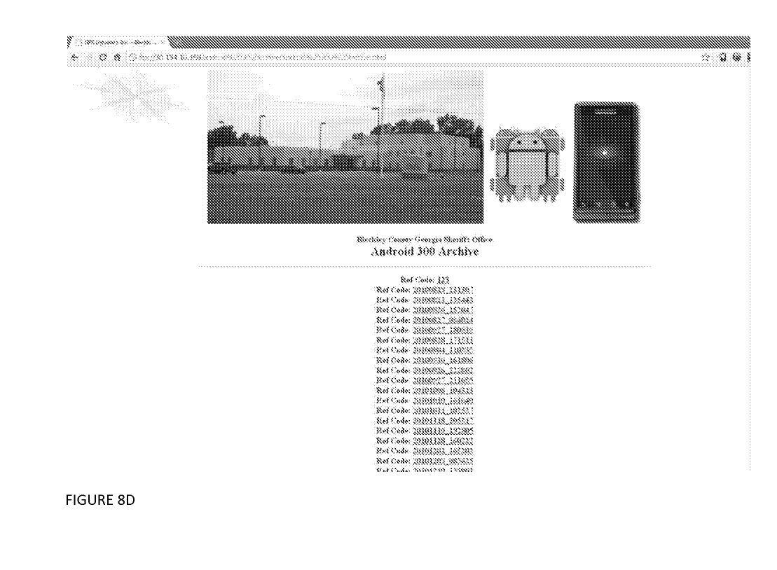

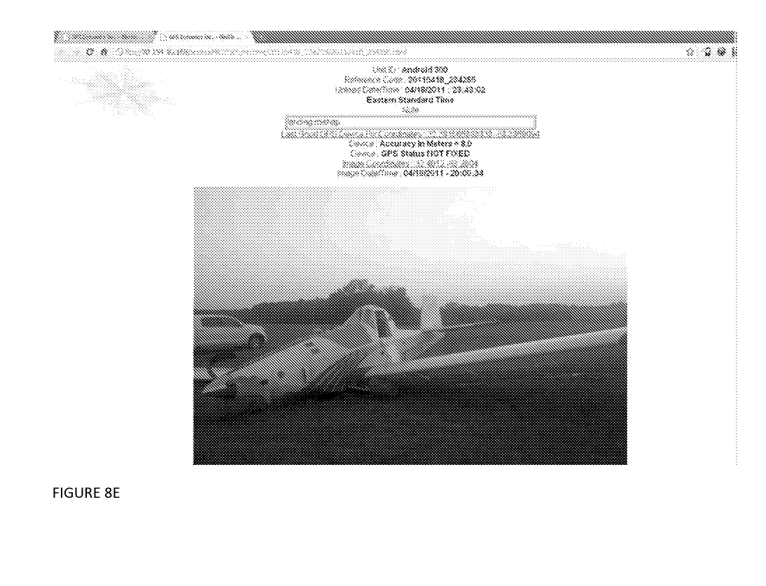

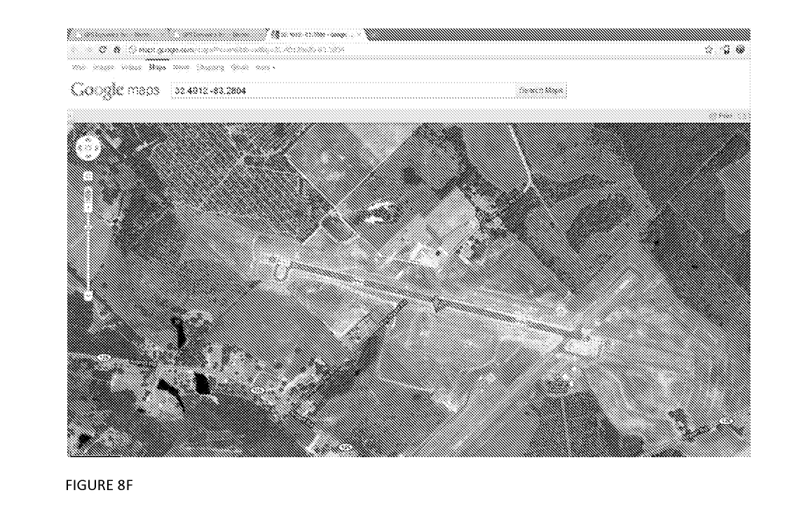

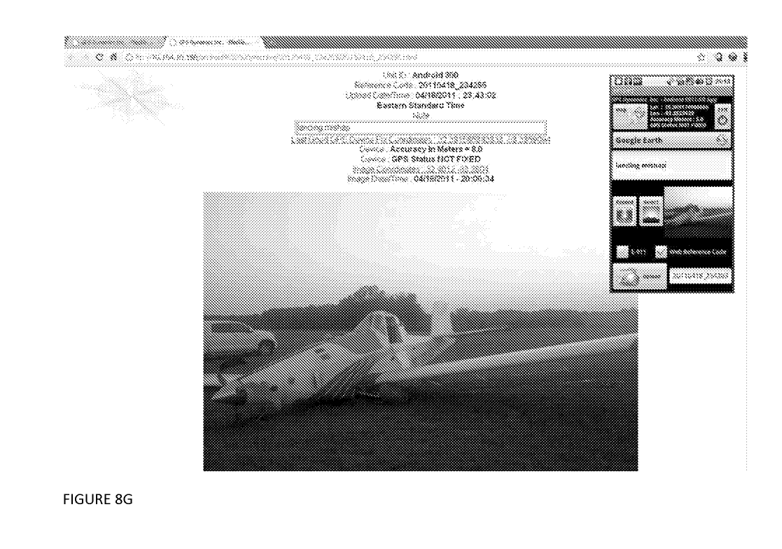

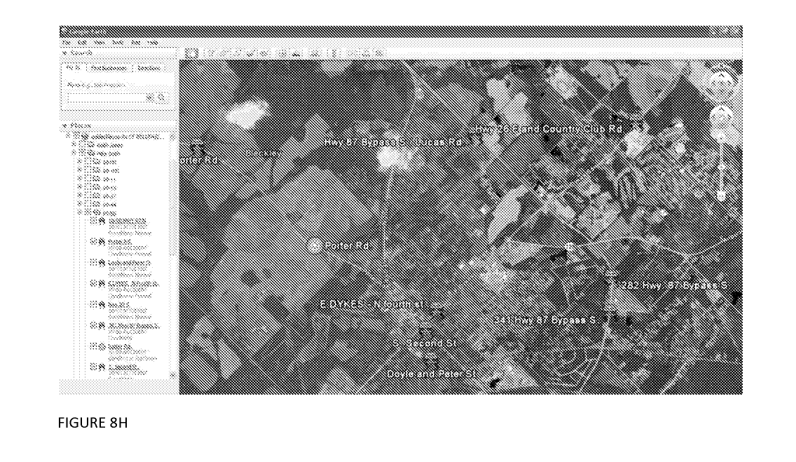

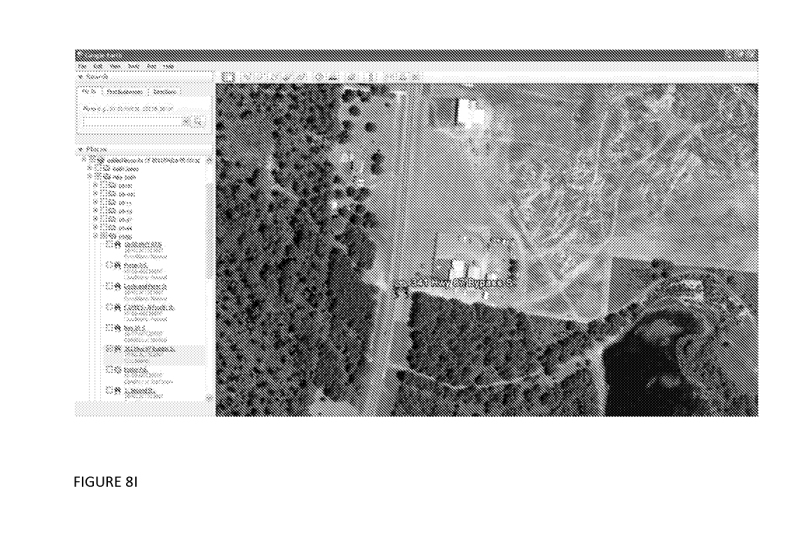

Once transmitted, the recipients may be E-911 operators, other first responders, or any number of individuals and/or systems that would make the best real-time use of the information in the incident report 102. For instance, the incident report may be transmitted to a server 108 that is accessible by and provides information directly to E-911 dispatchers and personnel. Such a server 108 may also be accessible by and provide information directly other emergency personnel and systems. Finally, such a server 108 may be secured and accessible via the World Wide Web and host software by which an authorized user may access the incident report 102 and associated data. FIGS. 8A-8I provide screen shots of the various information that an E-911 dispatcher or other individual with authorized access to the controlled server will see and may access. Screen shots in FIGS. 8A-8I are views of the various information compiled in an incident report 102 that are accessible via a secure server, such as incident scene photographs, geographic information, and any and all information that a responder may include in the report 102. A server may be configured to be searchable by any fields used in the incident reports 102, and such an application or server may facilitate sending the incident report 102 to another recipient via text message or E-mail or save the report as a calendar event.

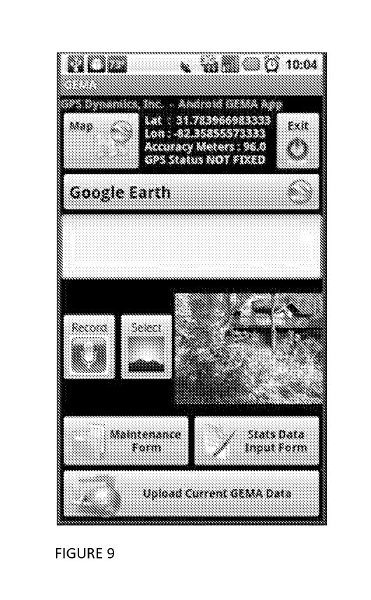

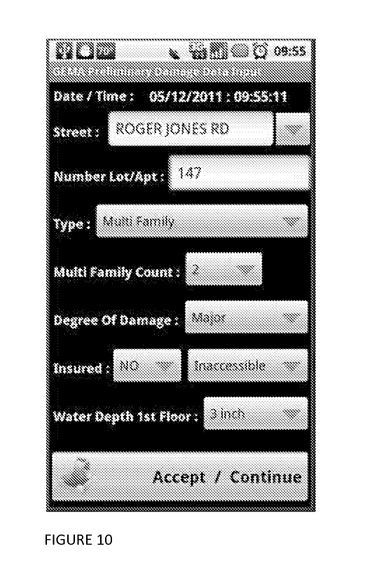

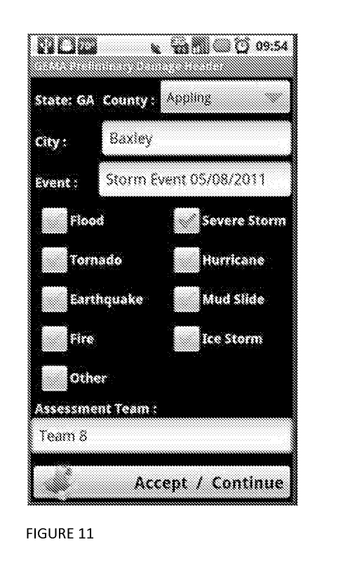

Emergency Personnel and Emergency managers in natural disasters may also use a wireless device and interactive Web site application in accordance with an embodiment of the present invention. Such an application may include information that can state the type of disaster, maps that can show “before” locations to assist responders and investigators with determining locations, and any other details necessary to create a natural disaster incident report 102. Such an application will also have the ability to combine various types of multi-media data, including notes, digital photographs or videos, and/or digital recordings with an incident record 102. FIG. 9 is an example of a home screen for such a natural disaster or emergency disaster type incident. FIG. 10 shows an example of an initial incident report for a natural disaster, and FIG. 11 shows an initial event window including types of incidents that a first-responder may select to associate with the natural disaster incident report.

It will be understood by one of ordinary skill in the art that although the figures and drawings herein disclose an application used on an Android® device, any other smart-phone platform such as iPhone® or BlackBerry® may be used. It will also be further understood by one of ordinary skill in the art that the menu options, information associated with the incident report, search options, and all other possible server and configurations are contemplated within the scope of an embodiment of the invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

I claim:

1. A method for creating an incident report with a wireless mobile device, comprising obtaining a GPS location fix and associating said GPS fix with an incident identifier for an incident, wherein said incident identifier incorporates a selection of laws and rules relevant to the incident, which can be searched and associated with the incident report.

2. The method of creating an incident report of claim 1, wherein said incident identifier is generated from a list of potential incident identifiers stored on an electronic storage means in communication with said wireless mobile device.

3. The method of creating an incident report of claim 1, further comprising creating an audio file and associating said audio file with said incident identifier.

4. The method of creating an incident report of claim 1, further comprising taking a digital photograph and associating said digital photograph with said incident identifier.

5. The method of creating an incident report of claim 1, further comprising recording a digital video and associating said digital video with said incident identifier.

6. The method of creating an incident report of claim 1, further comprising creating a digital text file and associating said digital text file with said incident.

7. The method of creating an incident report of claim 6, wherein said digital text file is created via voice-recognition application whereby said voice-recognition application translates a voice recording to said text file.

8. The method of creating an incident report of claim 1, further comprising said wireless mobile device transmitting said incident report to an Emergency 911 operator.

9. The method of creating an incident report of claim 1, further comprising said wireless mobile device transmitting said incident report to an electronic storage device.

10. The method of creating an incident report of claim 9, wherein said electronic storage device comprises a secured server.

11. The method of creating an incident report of claim 10, wherein said secured server may be accessible via the World Wide Web.

12. A system for creating an incident report, comprising:
a wireless communications device with an application saved thereon capable of:
fixing a GPS location;
associating said GPS location with an incident identifier;
recording a digital audio file and associating said audio file with said incident identifier;
capturing a digital image and associating said digital image with said incident identifier;
recording a digital video and associating said digital video with said Incident identifier;
searching a selection of laws and rules having identifying codes and associating the identifying codes with the incident report; and
saving notes and associating said digital video with said incident identifier;
a wireless communications network;
a computer network capable of communication with said wireless communications network; and
a server capable of communicating with said computer network.

13. The system of claim 12, wherein said wireless communications network is a cellular communications network.

14. The system of claim 12, wherein said computer network is the Internet

15. The system of claim 12, wherein said computer network is capable of transmitting data associated with the World Wide Web.

16. The system of claim 12, wherein said server is capable of hosting applications for the World Wide Web.

17. The system of claim 12, wherein said server is accessible only by authorized users.

18. A non-transitory processing device with a memory having executable instructions thereon for:
generating an incident report;
fixing a GPS location;
capturing a digital audio recording;
capturing a digital photograph;
capturing a digital video;
associating a selection of laws and rules relevant to the incident with the incident report;
compiling said incident report, said GPS location, said digital audio recording, said digital photograph, said digital video, and said selection of laws and rules into a single electronic file; and
transmitting said electronic file by a wireless network.
